(19) United States
(12) Patent Application Publication
(10) Pub. No.: US 2013/0143742 A1
(43) Pub. Date: Jun. 6, 2013

(54) HERBICIDAL COMPOSITION

(71) Applicant: SUMITOMO CHEMICAL COMPANY, LIMITED, Tokyo (JP)

(72) Inventor: Hajime IKEDA, Kasai-shi (JP)

(73) Assignee: SUMITOMO CHEMICAL COMPANY, LIMITED, Tokyo (JP)

(21) Appl. No.: 13/689,261

(22) Filed: Nov. 29, 2012

(30) Foreign Application Priority Data
Dec. 2, 2011 (JP) 2011-264373

(51) Int. Cl. A01N 57/20

(52) U.S. Cl. CPC A01N 57/20
USPC 504/128

(57) ABSTRACT

Disclosed is a herbicidal composition. The herbicidal composition comprises flumioxazin, saflufenacil, and glyphosate or a salt thereof.

### BACKGROUND OF THE INVENTION

1. Field of the Invention

The present invention relates to a herbicidal composition.

2. Description of the Related Art

A large number of compounds are known as herbicides for controlling weeds.

### [Prior Art Document]

### [Non-Patent Document]

### [Non-Patent Document 1]

Herbicide Handbook, Ninth Edition (2007) Weed Science Society of America, ISBN: 1-891276-56-5)

### [Non-Patent Document 2]

Crop Protection Handbook, Vol. 97 (2011) Meister Publishing Company, ISBN: 1-892829-23-1)

### [Patent Document]

### [Patent Document 1]

U.S. Pat. No. 3,799,758

### [Patent Document 2]

U.S. Pat. No. 4,640,707

### [Patent Document 3]

International Publication No. WO 2001/083459

### [Patent Document 4]

International Publication No. WO 2011/008453

### SUMMARY OF THE INVENTION

An object of the present invention is to provide a herbicidal composition which exhibits a high herbicidal activity against weeds.

The present inventor has intensively studied so as to find a herbicidal composition which exhibits a high herbicidal activity against weeds, and found that a composition in combination with specific herbicides exhibits a high herbicidal activity against weeds without causing significant phytotoxicity to crops, and thus leading to the present invention.

The present invention includes the followings:

[1] A herbicidal composition comprising flumioxazin, saflufenacil, and glyphosate or a salt thereof;

[2] The herbicidal composition according to [1], wherein the weight ratio of flumioxazin to saflufenacil is from 1:0.02 to 1:30;

[3] The herbicidal composition according to [1], wherein the weight ratio of flumioxazin to glyphosate or a salt thereof is from 1:0.2 to 1:200 in terms of the weight of glyphosate;

[4] The herbicidal composition according to any one of [1] to [3], wherein the salt of glyphosate is a potassium salt, a sodium salt, an isopropylamine salt, a trimesium salt, an ammonium salt, a diammonium salt or a guanidine derivative salt;

[5] The herbicidal composition according to any one of [1] to [3], wherein the salt of glyphosate is a potassium salt;

[6] A method for controlling weeds, which comprises applying an effective amount of flumioxazin, saflufenacil, and glyphosate or a salt thereof to soil or weeds in a place where the weeds grow or will grow;

[7] The method according to [6], wherein the weight ratio of flumioxazin to saflufenacil is from 1:0.02 to 1:30;

[8] The method according to [6], wherein the weight ratio of flumioxazin to glyphosate or a salt thereof is within a range from 1:0.2 to 1:200 in terms of the weight of glyphosate;

[9] The method according to any one of [6] to [8], wherein the salt of glyphosate is a potassium salt, a sodium salt, an isopropylamine salt, a trimesium salt, an ammonium salt, a diammonium salt or a guanidine derivative salt;

[10] The method according to any one of [6] to [8], wherein the salt of glyphosate is a potassium salt;

[11] The method according to any one of [6] to [10], which is a method for controlling weeds in a soybean field and a corn field; and

[12] The method according to any one of [6] to [10], which is a method for controlling weeds in a tree land.

The herbicidal composition of the present invention can control a wide variety of weeds without causing significant phytotoxicity to crops.

### DETAILED DESCRIPTION OF THE INVENTION

The herbicidal composition of the present invention (hereinafter referred to as a composition of the present invention) comprises flumioxazin, saflufenacil, glyphosate or a salt thereof.

Flumioxazin (N-(7-fluoro-3,4-dihydro-3-oxo-4-prop-2-ynyl-2H-1,4-benzoxazin-6-yl)cyclohex-1-ene-1,2-dicarboxamide), saflufenacil (N′-{2-chloro-4-fluoro-5-[1,2,3,6-tetrahydro-3-methyl-2,6-dioxo-4-(trifluoromethyl)pyrimidin-1-yl]benzoyl}-N-isopropyl-N-methylsulfamide) and glyphosate (N-(phosphonomethyl)glycine) used in the composition of the present invention are herbicidally active compounds described in U.S. Pat. No. 4,640,707, International Publication No. WO 2001/083459, U.S. Pat. No. 3,799,758 and/or Crop Protection Handbook, Vol. 97 (2011), and they can be produced by a known production method, and also formulations containing them are available on the market.

Glyphosate or a salt thereof used in the composition of the present invention may be either in a form of an acid of glyphosate, or a form of a salt of glyphosate, and a form of a salt of glyphosate is usually used. In the case of referring to glyphosate in the present invention, the glyphosate refers to a form of an acid of glyphosate.

Specific examples of the salt of glyphosate include glyphosate-isopropylamine, glyphosate-trimethylsulfonium, glyphosate-ammonium, glyphosate-diammonium, glyphosate-sodium, glyphosate-potassium and glyphosate guanidine derivative salts. These salts of glyphosate are described in Herbicide Handbook, Ninth Edition (2007), Crop Protection Handbook, Vol. 97(2011), U.S. Pat. No. 3,799,758 or International Publication No. WO 2011/008453, and they can be produced by a known production method, and also formulations containing them are available on the market.

The composition of the present invention has herbicidal activity against a wide variety of weeds, and thus enabling effective control of a wide variety of weeds in the fields where crops are usually cultivated with or without tillage, vegetable field, tree land or non-cultivated land. Furthermore, the composition does not cause significant phytotoxicity to useful plants.

Examples of the farm crop field in the present invention include fields of edible crops such as peanut, soybean, corn, wheat and barley; feed crops such as sorghum and oat; industrial crops such as cotton; and sugar crops such as sugarcane. Examples of the vegetable field in the present invention include fields of Solanaceae vegetables such as eggplant, tomato, green pepper, red pepper and potato; Cucurbitaceae vegetables such as cucumber, pumpkin, zucchini, watermelon and melon; Brassicaceae vegetables such as radish, turnip, horseradish, cohlrabi, Chinese cabbage, cabbage, leaf mustard, broccoli and cauliflower; Compositae vegetables such as burdock, crown daisy, artichoke and lettuce; Liliaceae vegetables such as leek, onion, garlic and asparagus; Umbelliferae vegetables such as carrot, parsley, celery and parsnip; Chenopodiaceae vegetables such as spinach and Swiss chard; Lamiacea vegetables such as perilla, mint, basil and lavender; strawberry; sweet potato; yam; and taro.

Examples of the tree land in the present invention include orchards, tea plantation, mulberry field, coffee plantation, banana plantation, palm plantation, flower tree land, flower field, nursery tree land, young plant land, forest and garden. Examples of the orchard include pome fruits such as apple, pear, Japanese pear, Chinese quince and quince; stone fruits such as peach, plum, nectarine, Japanese apricot, cherry, apricot and prune; citrus such as Satsuma orange, orange, lemon, lime and grapefruit; tree nuts such as chestnut, walnut, hazelnut, almond nut, pistachio nut, cashew nut and macadamia nut; berries such as blueberry, cranberry, blackberry and raspberry; grape; persimmon; olive; and loquat.

Examples of the non-cultivated land in the present invention include playground, vacant land, neighborhood of railroad, park, car park, neighborhood of road, dry riverbed, land under power-transmission lines, land for housing and site for factor.

Crops cultivated in the farm crop field in the present invention are not limited as long as they belong to cultivars which are generally cultivated as crops.

These plant cultivars include plants, to which resistance to herbicides has been imparted by a classical breeding method or genetic recombination technology, the herbicides being protoporphyrinogen IX oxidase inhibitors such as flumioxazin; 4-hydroxyphenylpyruvate dioxygenase inhibitors such as isoxaflutole; acetolactate synthase inhibitors such as imazethapyr and thifensulfuron-methyl; acetyl CoA carboxylase inhibitors such as sethoxydim; 5-enolpyruvylshikimate-3-phosphate synthase inhibitors such as glyphosate; glutamine synthase inhibitors such as glufosinate; auxin type herbicides such as 2,4-D and dicamba; and bromoxynil.

Examples of the crop, to which resistance to herbicides has been imparted by a classical breeding method, include corn which is resistant to an imidazolinone type acetolactate synthase inhibiting herbicide such as imazethapyr, and which has already been sold under the trade name of Clearfield (registered trademark). Such a crop also includes STS soybean which is resistant to a sulfonylurea type acetolactate synthase inhibiting herbicide such as thifensulfuron-methyl. Similarly, examples of the plant, to which resistance to an acetyl CoA carboxylase inhibitor such as a trione oxime or aryloxyphenoxypropionic acid type herbicide has been imparted by a classical breeding method, include SR corn.

Examples of the plant, to which resistance to herbicides has been imparted by genetic recombination technology, include corn, soybean and cotton, each having resistance to glyphosate, and which have already been sold under the trade names of RoundupReady (registered trademark), Agrisure (registered trademark) GT, and Gly-Tol (registered trademark). Similarly, plants, to which resistance to herbicides has been imparted by genetic recombination technology, include corn, soybean and cotton, each having resistance to glufosinate, and they have already been sold under the trade name of LibertyLink (registered trademark). There are corn and soybean cultivars, which are resistant to both glyphosate and ALS inhibitors, and are sold under the trade name of Optimum (registered trademark) GAT (registered trademark). Similarly, there is soybean, to which resistance to an imidazolinone type acetolactate synthase inhibitor has been imparted by genetic recombination technology, and which has been developed under the trade name of Cultivance. Similarly, there is cotton, to which resistance to bromoxynil has been imparted by genetic recombination technology, and which has already been sold under the trade name of BXN (registered trademark).

Crops such as soybean having resistance to dicamba can be fabricated by introducing a dicamba-degrading enzyme such as dicamba monooxygenase isolated from Pseudomonas maltophilia into the plant (Behrens et al. 2007 Science 316: 1185-1188).

Crops having resistance to both phenoxy acid type herbicidez such as 2,4-D, MCPA, dichlorprop and mecoprop, and aryloxyphenoxypropionic acid type herbicides such as quizalofop, haloxyfop, fluazifop, diclofop, fenoxaprop, metamifop, cyhalofop and clodinafop can be fabricated by introducing a gene encoding an aryloxyalkanoate dioxygenase (Wright et al. 2010: Proceedings of National Academy of Science. 107(47): 20240-20245).

By introducing a gene encoding a 4-hydroxyphenylpyruvate dioxygenase (hereinafter referred to as HPPD) inhibitor which exhibits resistance to HPPD inhibitor, and thus plants having resistance to the HPPD inhibitor can be fabricated (US2004/0058427). By introducing a gene capable of synthesizing homogentisic acid as a product of HPPD through another metabolic pathway, homogentisic acid is produced even in the presence of a HPPD inhibitor, and thus making it possible to fabricate plants which exhibits resistance to the HPPD inhibitor (WO 02/036787). By introducing a gene capable of excessively expressing HPPD, HPPD is produced in the amount which does not exert an adverse influence on the growth of the plant even in the presence of a HPPD inhibitor, and thus making it possible to fabricate plants which exhibit resistance to the HPPD inhibitor (WO 96/38567). By introducing aforementioned gene capable of excessively expressing HPPD and also introducing a gene encoding a prephenate dehydrogenase so as to increase the production amount of p-hydroxyphenylpyruvic acid as a substrate of HPPD, and thus making it possible to fabricate plants which exhibit resistance to the HPPD inhibitor (Rippert P et al. 2004 Engineering plant shikimate pathway for production of tocotrienol and improving herbicide resistance. Plant Physiol. 134: 92-100).

Examples of the other method of imparting resistance to a herbicide include methods of introducing genes described in WO 98/20144, WO 2002/46387 and US2005/0246800.

Aforementioned crops also include crops which made it possible to synthesize selective toxins known as the genus Bacillus, using genetic recombination technology.

Examples of toxins expressed in these transgenic plants include insecticidal proteins derived from Bacillus cereus and Bacillus popilliae; δ-endotoxins derived from Bacillus thuringiensis, e.g. Cry1Ab, Cry1Ac, Cry1F, Cry1Fa2, Cry2Ab, Cry3A, Cry3Bb1 and Cry9C, and insecticidal proteins such as VIP1, VIP2, VIP3 and VIP3A; insecticidal toxins derived from nematodes; insecticidal toxins produced by animals, such as scorpion toxin, spider toxin, bee toxin and insect-specific neurotoxins; filamentous fungi toxins; plant lectins; agglutinin; protease inhibitor such as trypsin inhibitor, serine protease inhibitor, patatin, cystatin and papain inhibitor; ribosome-inactivating proteins (RIP) such as ricin, corn-RIP, abrin, rufin, sapolin and priodin; steroid metabolic enzymes such as 3-hydroxysteroid oxidase, ecdysteroid-UDP-glucosyltransferase and cholesterol oxidase; ecdysone inhibitor; HMG-CoA reductase; ion channel inhibitors such as sodium channel inhibitor and calcium channel inhibitor; juvenile hormone esterase; diuretic hormone acceptors; stilbene synthetase; bibenzyl synthetase; chitinase; and glucanase.

The toxins expressed in these transgenic plants include δ-endotoxin proteins such as Cry1Ab, Cry1Ac, Cry1F, Cry1Fa2, Cry2Ab, Cry3A, Cry3Bb1, Cry9C, Cry34Ab and Cry35Ab, hybrid toxins of insecticidal proteins such as VIP1, VIP2, VIP3 and VIP3A, partially deficient toxins, and modified toxins. The hybrid toxins are fabricated by a novel combination of the different domains of these proteins, using genetic recombination technology. The known partially deficient toxin is Cry1Ab, in which a part of amino acid sequence is deficient. In modified toxins, one or more amino acids of a natural toxin are replaced. Examples of these toxins and transgenic plants capable of synthesizing these toxins are described in EP-A-0 374 753, WO 93/07278, WO 95/34656, EP-A-0 427 529, EP-A-451 878, and WO 03/052073. The toxins contained in these transgenic plants impart resistance to insect pests of Coleoptera, insect pests of Diptera and insect pests of Lepidoptera to the plants.

There have already been known transgenic plants having one or more insecticidal pest-resistant genes and capable of producing one or more toxins, and some of them are commercially available. Examples of the transgenic plants include YieldGard (registered trademark) (a corn variety expressing Cry1Ab toxin), YieldGard Rootworm (registered trademark) (a corn variety expressing Cry3Bb1 toxin), YieldGard Plus (registered trademark) (a corn variety expressing Cry1Ab and Cry3Bb1 toxins), Herculex I (registered trademark) (a corn variety expressing Cry1Fa2 toxin and phosphinothricin N-acetyltransferase (PAT) to impart resistance to glufosinate), NatureGard (registered trademark), AGRISURE (registered trademark) CB Advantage (Bt11 corn borer (CB) character), and Protecta (registered trademark).

There have already been known transgenic cottons having one or more insecticidal pest-resistant genes and capable of producing one or more toxins, and some of them are commercially available. Examples of the transgenic cottons include BollGard (registered trademark) (cotton cultivar expressing a Cry1Ac toxin), BollGard (registered trademark) II (cotton cultivar expressing Cry1Ac and Cry2Ab toxins), BollGard (registered trademark) III (cotton cultivar expressing Cry1Ac, Cry2Ab and VIP3A toxins), VipCot (registered trademark) (cotton cultivar expressing a VIP3A and Cry1Ab toxins) and WideStrike (registered trademark) (cotton cultivar expressing Cry1Ac and Cry1F toxins).

Examples of the plant used in the present invention include plants imparted with resistance to aphidas, such as soybean having a Rag1 (Resistance Aphid Gene1) gene introduced thereinto.

The above crops also include those imparted with a capacity of producing an anti-pathogenic substance having selective activity. As the anti-pathogenic substance, PR proteins (PRPs, EP-A-0 392 225) are known. These anti-pathogenic substances and transgenic plants producing thereof are described in EP-A-0 392 225, WO 95/33818, and EP-A-0 353 191. Examples of the anti-pathogenic substance expressed by the transgenic plants include ion channel inhibitors such as a sodium channel inhibitor and calcium channel inhibitor (KP1, KP4 and KP6 toxins produced by viruses are known); stilbene synthases; bibenzyl synthases; chitinase; glucanase; PR proteins; and substances produced by microorganisms, such as peptide antibiotics, antibiotics having a heterocyclic ring and protein factors (called genes resistant to plant diseases and are described in WO 03/000906) involved in plant disease resistance.

The above crops include those imparted with useful traits, such as reformed oil component and enhanced amino acid content, by means of a genetic recombination technique. The crops are exemplified by VISTIVE (registered trademark) (low linolenic soybean with reduced linolenic acid content) and high-lysine (high-oil) corn (corn with increased lysine or oil content).

The crops further include stacked varieties, which are fabricated by combining the above classical herbicidal traits or herbicide resistant genes, insecticidal pest resistant genes, anti-pathogenic substance-producing genes, reformed oil component and enhanced amino acid content.

Examples of weeds capable of controlling the composition of the present invention include the followings.

Urticaceae weeds: anual nettle (Urtica urens);

Polygonaceous weeds: wild buckwheat (Polygonum convolvulus), pale smartweed (Polygonum lapathifolium), pennsylvania smartweed (Polygonum pensylvanicum), ladysthumb (Polygonum persicaria), tufted knotweed (Polygonum longisetum), knotweed (Polygonum aviculare), common knotweed (Polygonum arenastrum), Japanese knotweed (Polygonum cuspidatum), Japanese dock (Rumex japonicus), curly dock (Rumex crispus), broad-leaved dock (Rumex obtusifolius), and Sorrel (Rumex acetosa);

Portulacaceous weeds: common purslane (Portulaca oleracea);

Caryophyllaceous weeds: common chickweed (Stellaria media), mouse ear chickweed (Cerastium holosteoides), sticky chickweed (Cerastium glomeratum), corn spurry (Spergula arvensis), and common catchfly (Silene gallica);

Molluginaceae weeds: carpetweed (Mollugo verticillata)

Chenopodiaceous weeds: common lambsquarters (Chenopodium album), American wormseed (Chenopodium ambrosioides), burningbush (Kochia scoparia), tumble weed (Salsola kali), and Atriplex spp.;

Amaranthaceous weeds: redroot pigweed (Amaranthus retroflexus), slender amaranth (Amaranthus viridis), livid amaranth (Amaranthus lividus), spiny amaranth (Amaranthus spinosus), smooth pigweed (Amaranthus hybridus), palmer amaranth (Amaranthus palmeri), common waterhemp (Amaranthus rudis), smooth pigweed (Amaranthus patulus), rough-fruit amaranth (Amaranthus tuberculatos), mat amaranth (Amaranthus blitoides), large-fruited amaranth (Amaranthus deflexus), Amaranthus quitensis, alligatorweed (Alternanthera philoxeroides), alligator weed (Alternanthera sessilis), and Sanguinarea (Alternanthera tenella);

Papaveraceae weeds: corn poppy (Papaver rhoeas) and Mexican prickly poppy (Argemone mexicana);

Cruciferous weeds: wild radish (Raphanus raphanistrum), radish (Raphanus sativus), wild mustard (Sinapis arvensis), shepherd spurse (Capsella bursa-pastoris), brown mustard (Brassica juncea), wild turnip (Brassica campestris), tansy mustard (Descurainia pinnata), yellow marsh-cress (Rorippa islandica), yellow fieldcress (Rorippa sylvestris), field penny-cress (Thlaspi arvense), annual bastard-cabbage (Myagrum rugosum), Virginia pepperweed (Lepidium virginicum), and lesser swinecress (Coronopus didymus);

Capparaceae weeds: Cleome affinis;

Leguminosae weeds: indian jointvetch (Aeschynomene indica), zigzag jointvetch (Aeschynomene rudis), coffeeweed (Sesbania exaltata), sicklepod (Cassia obtusifolia), coffee senna (Cassia occidentalis), dixie ticktrefoil (Desmodium tortuosum), bush groundnut (Desmodium adscendens), Dutch clover (Trifolium repens), kudzu (Pueraria lobata), common vetch (Vicia angustifolia), hairy indigo (Indigofera hirsuta), Indigofera truxillensis, and cowpea (Vigna sinensis);

Oxalidaceae weeds: woodsorrel (Oxalis corniculata), yellow wood sorrel (Oxalis strica), and Oxalis oxyptera;

Geraniaceae weeds: carolina geranium (Geranium carolinense) and redstem storksbill (Erodium cicutarium);

Euphorbiaceous weeds: sun spurge (Euphorbia helioscopia), spotted spurge (Euphorbia maculata), prostrate spurge (Euphorbia humistrata), leafy spurge (Euphorbia esula), Mexican fire plant (Euphorbia heterophylla), para rubber tree (Euphorbia brasiliensis), Australian acalypha (Acalypha australis), tropic croton (Croton glandulosus), lobed croton (Croton lobatus), Mascarene island leaf-flower (Phyllanthus corcovadensis), and castor bean (Ricinus communis);

Malvaceous weeds: velvetleaf (Abutilon theophrasti), arrowleaf sida (Sida rhombiforia), flannelweed (Sida cordifolia), prickly sida (Sida spinosa), Sida glaziovii, Sida santaremnensis, venice mallow (Hibiscus trionum), spurred anoda (Anoda cristata), and broomweed (Malvastrum coromandelianum);

Sterculioideae weeds: uhaloa (Waltheria indica);

Violaceous weeds: field pansy (Viola arvensis) and wild pansy (Viola tricolor);

Cucurbitaceae weeds: burcucumber (Sicyos angulatus), wild cucumber (Echinocystis lobata), and bitter cucumber (Momordica charantia);

Lythraceae weeds: purple loosestrife (Lythrum salicaria);

Apiaceae weeds: water pennywort (Hydrocotyle sibthorpioides);

Sapindaceae weeds: balloon vine (Cardiospermum halicacabum);

Primulaceae weeds: Scarlet pimpernel (Anagallis arvensis);

Asclepiadaceae weeds: common milkweed (Asclepias syriaca) and honeyvine milkweed (Ampelamus albidus);

Rubiaceous weeds: catchweed bedstraw (Galium aparine), catchweed (Galium spurium var. echinospermon), broadleaf buttonweed (Spermacoce latifolia), Mexican clover (Richardia brasiliensis), and winged false buttonweed (Borreria alata);

Convolvulaceous weeds: Japanese morning glory (Ipomoea nil), ivyleaf morning glory (Ipomoea hederacea), tall morning glory (Ipomoea purpurea), entireleaf morning glory (Ipomoea hederacea var. integriuscula), pitted morning glory (Ipomoea lacunosa), threelobe morning glory (Ipomoea triloba), blue morning glory (Ipomoea acuminata), scarlet morning glory (Ipomoea hederifolia), red morning glory (Ipomoea coccinea), cypressvine morning glory (Ipomoea quamoclit), Ipomoea grandifolia, Ipomoea aristolochiafolia, ivy-leaved morning glory (Ipomoea cairica), field bindweed (Convolvulus arvensis), Japanese false bindweed (Calystegia hederacea), Japanese bindweed (Calystegia japonica), german ivy (Merremia hedeacea), hairy woodrose (Merremia aegyptia), roadside woodrose (Merremia cissoides), and hairy clustervine (Jacquemontia tamnifolia);

Boraginaceous weeds: forget-me-not (Myosotis arvensis);

Labiate weeds: purple deadnettle (Lamium purpureum), henbit deadnettle (Lamium amplexicaule), christmas candlestick (Leonotis nepetaefolia), pignut (Hyptis suaveolens), Hyptis lophanta, honeyweed (Leonurus sibiricus), and stagger weed (Stachys arvensis);

Solanaceous weeds: jimsonweed (Datura stramonium), black nightshade (Solanum nigrum), American nightshade (Solanum americanum), Eastern black nightshade (Solanum ptycanthum), hairy nigthtshade (Solanum sarrachoides), buffalobur (Solanum rostratum), Dutch eggplant (Solanum aculeatissimum), sticky nightshade (Solanum sisymbriifolium), horsenettle (Solanum carolinense), ground cherry (Physalis angulata), smooth groundcherry (Physalis subglabrata), and shoo-fly plant (Nicandra physaloides);

Scrophulariaceae weeds: ivyleaf speedwell (Veronica hederaefolia), Persian speedwell (Veronica persica), and corn speedwell Veronica arvensis);

Plantaginaceae weed: Chinese plantain (Plantago asiatica);

Compositae weeds: common cocklebur (Xanthium pensylvanicum), noogoora burr (Xanthium occidentale), common sunflower (Helianthus annuus), chamomile (Matricaria chamomilla), scentess chamomile (Matricaria perforata), corn marigold (Chrysanthemum segetum), pineappleweed (Matricaria matricarioides), mugwort (Artemisia princeps), common mugwort (Artemisia vulgaris), Chinese mugwort (Artemisia verlotorum), tall goldenrod (Solidago altissima), dandelion (Taraxacum officinale), hairy galinsoga (Galinsoga ciliata), Smallfower galinsoga (Galinsoga parviflora), common groundsel (Senecio vulgaris), Senecio brasiliensis, Senecio grisebachii, hairy fleabane (Conyza bonariensis), Horseweed (Conyza canadensis), ragweed (Ambrosia artemisiaefolia), giant ragweed (Ambrosia trifida), Hairy begger-ticks (Bidens pilosa), devil's beggartick (Bidens frondosa), Bidens subalternans, creeping thistle (Cirsium arvense), bull thistle (Cirsium vulgare), milk thistle (Silybum marianum), musk thistle (Carduus nutans), prickly lettuce (Lactuca serriola), sow thistle (Sonchus oleraceus), spiny sowthistle (Sonchus asper), beach creeping oxeye (Wedelia glauca), perfoliate blackfoot (Melampodium perfoliatum), cupid's shaving brush (Emilia sonchifolia), wild marigold (Tagetes minute), para cress (Blainvillea latifolia), coat buttons (Tridax procumbens), yerba porosa (Porophyllum ruderale), paraguay starbur (Acanthospermum australe), bristly starbur (Acanthospermum hispidum), heart seed (Cardiospermum halicacabum), blue top (Ageratum conyzoides), common boneset (Eupatorium perfoliatum), false daisy (Eclipta alba), American burnweed (Erechtites hieracifolia), American everlasting (Gamochaeta spicata), shiny cudweed (Gnaphalium spicatum), Jaegeria hirta, carrot grass (Parthenium hysterophorus), Menamomi (Siegesbeckia orientalis), and weeping lovegrass (Soliva sessilis);

Liliaceae weeds: wild onion (Allium canadense) and wild garlic (Allium vineale);

Commelinaceae weeds: asiatic dayflower (Commelina communis), Bengal dayflower (Commelina bengharensis), and erect dayflower (Commelina erecta);

Graminaceous weeds: barnyardgrass (Echinochloa crus-galli), green foxtail (Setaria viridis), giant foxtail (Setaria faberi), yellow foxtail (Setaria glauca), knotroot foxtail (Setaria geniculata), southern crabgrass (Digitaria ciliaris), large crabgrass (Digitaria sanguinalis), Jamaican crabgrass (Digitaria horizontalis), sourgrass (Digitaria insularis), goosegrass (Eleusine indica), annual bluegrass (Poa annua), orange foxtail (Alospecurus aequalis), blackgrass (Alopecurus myosuroides), wild oat (Avena fatua), johnsongrass (Sorghum halepense), shattercane (Sorghum vulgare), quackgrass (Agropyron repens), Italian ryegrass (Lolium multiflorum), perennial ryegrass (Lolium perenne), wimmera ryegrass (Lolium rigidum), rye brome (Bromus secalinus), downy brome (Bromus tectorum), foxtail barley (Hordeum jubatum), goatgrasses (Aegilops cylindrica), reed canarygrass (Phalaris arundinacea), lesser cabrygrass (Phalaris minor), silky bentgrass (Apera spica-venti), fall panicum (Panicum dichotomiflorum), Texas panicum (Panicum texanum), Guinea grass (Panicum maximum), broadleaf signaigrass (Brachiaria platyphylla), ruzigrass (Brachiaria ruziziensis), alexandergrass (Brachiaria plantaginea), surinam grass (Brachiaria decumbens), pallisade grass (Brachiaria brizantha), koronivia grass (Brachiaria humidicola), common sandbur (Cenchrus echinatus), spiny burr grass (Cenchrus pauciflorus), woolly cupgrass (Eriochloa villosa), Pennisetum (Pennisetum setosum), rhodes grass (Chloris gayana), Jersey love grass (Eragrostis pilosa), ruby grass (Rhynchelitrum repens), crowfoot grass (Dactyloctenium aegyptium), ribbed murainagrass (Ischaemum rugosum), rice (Oryza sativa), bahia grass (Paspalum notatum), coastal sand paspalum (Paspalum maritimum), kikuyugrass (Pennisetum clandestinum), fountaingrass (Pennisetum setosum), and itch grass (Rottboellia cochinchinensis);

Cllitrichaceae weeds: amur cyperus (Cyperus microiria), ricefield flatsedge (Cyperus iria), rice flatsedge (Cyperus odoratus), nut grass (Cyperus rotundus), yellow nutsedge (Cyperus esculentus), and pasture spikesedge (Kyllinga gracillima); and

Equisetaceous weeds: field horsetail (Equisetum arvense) and marsh horsetail (Equisetum palustre).

In the composition of the present invention, the weight ratio of flumioxazin to saflufenacil is within a range from 1:0.01 to 1:50, preferably from 1:0.02 to 1:30, more preferably from 1:0.04 to 1:20, and still more preferably from 1:0.1 to 1:10.

In the composition of the present invention, the weight ratio of flumioxazin to glyphosate or a salt thereof is within a range from 1:0.1 to 1:400, preferably from 1:0.2 to 1:200, more preferably from 1:0.4 to 1:100, and more preferably from 1:5 to 1:50, in terms of the weight of glyphosate.

In the composition of the present invention, the weight ratio (flumioxazin:saflufenacil:glyphosate or a salt thereof (in terms of the weight of glyphosate)) is usually 1:0.01-50:0.1-400, preferably 1:0.02-30:0.2-200, more preferably from 1:0.04-20:0.4-100, still more preferably 1:0.1-10:5-50.

The composition of the present invention is usually formulated to emulsifiable concentrates, wettable powders, suspension concentrates, granules, and the like by mixing with a solid carrier or a liquid carrier and optionally adding surfactants and the other auxiliaries for formulation. These formulations contain about 0.1 to 90% by weight, and preferably about 1 to 80% by weight of the total amount of flumioxazin, saflufenacil, and glyphosate or a salt thereof.

Examples of the solid carrier used for formulating the composition of the present invention include fine powders and granules of clays such as kaolinite, diatomaceous earth, synthetic hydrated silica, Fubasami clay, bentonite and acid clay; talc; other inorganic minerals such as sericite, quartz powder, sulfur powder, activated carbon and calcium carbonate; and chemical fertilizer such as ammonium sulfate, ammonium phosphate, ammonium nitrate, ammonium chloride and urea. Examples of the liquid carrier include water; alcohols such as methanol and ethanol; ketones such as acetone, methyl ethyl ketone and cyclohexanone; aromatic hydrocarbons such as toluene, xylene, ethylbenzene and methylnaphthalene; non-aromatic hydrocarbons such as hexane, cyclohexane and kerosene; esters such as ethyl acetate and butyl acetate; nitriles such as acetonitrile and isobutyronitrile; ethers such as dioxane and diisopropyl ether; acid amides such as dimethylformamide and dimethylacetamide; and halogenated hydrocarbons such as dichloroethane and trichloroethylene.

Examples of the surfactant used for formulating the composition of the present invention include alkyl sulfate esters, alkylsulfonate salts, alkylarylsulfonate salts, alkylaryl ethers, polyoxyethylene alkylaryl ethers, polyethylene glycol ethers, polyhydric alcohol esters and sugar alcohol derivatives. Examples of the other auxiliary for formulation include sticking agents and dispersants, such as casein; gelatin; polysaccharides such as starch, gum arabic, cellulose derivatives and alginic acid; lignin derivatives; bentonite; and synthetic water-soluble polymers such as polyvinyl alcohol, polyvinylpyrrolidone and polyacrylic acid; and stabilizers such as PAP (isopropyl acid phosphate), BHT (2,6-tert-butyl-4-methylphenol), BHA (2-/3-tert-butyl-4-methoxyphenol), vegetable oil, mineral oil, fatty acid and fatty acid ester.

The composition of the present invention can be prepared by mixing each formulation after formulating each of the ingredients using the above-mentioned procedure.

The thus formulated composition of the present invention may be sprayed as it is. Alternatively, the composition is diluted with water or the like, and then the dilution is sprayed over soil or a plant. It may be expected to enhance the herbicidal effect by using the composition of the present invention together with other herbicides.

Furthermore, the composition is used in combination with insecticides, fungicides, plant growth regulators, fertilizers, safeners, soil-improving agents, and the like.

Examples of the other herbicides include the following:

dicamba and a salt thereof (diglycolamine salt, dimethylammonium salt, isopropylammonium salt, potassium salt, sodium salt, choline salt), 2,4-D and a salt or ester thereof (butotyl ester, dimethylammonium salt, diolamine salt, ethylhexyl ester, isooctyl ester, isopropylammonium salt, sodium salt, triisopropanolamine salt, choline salt), 2,4-DB and a salt or ester thereof (dimethylammonium salt, isooctyl ester, choline salt), MCPA and a salt or ester thereof (dimethylammonium salt, 2-ethylhexyl ester, isooctyl ester, sodium salt, choline salt), MCPB, mecoprop and a salt or ester thereof (dimethylammonium salt, diolamine salt, ethadyl ester, 2-ethylhexyl ester, isooctyl ester, methyl ester, potassium salt, sodium salt, trolamine salt, choline salt), mecoprop-P and a salt or ester thereof (dimethylammonium salt, 2-ethylhexyl ester, isobutyl salt, potassium salt, choline salt), dichlorprop and a salt or ester thereof (butotyl ester, dimethylammonium salt, 2-ethylhexyl ester, isooctyl ester, methyl ester, potassium salt, sodium salt, choline salt), dichlorprop-P, dichlorprop-P-dimethylammonium, bromoxynil, bromoxynil-octanoate, dichlobenil, ioxynil, ioxynil-octanoate, di-allate, butylate, tri-allate, phenmedipham, chlorpropham, asulam, phenisopham, benthiocarb, molinate, esprocarb, pyributicarb, prosulfocarb, orbencarb, EPTC, dimepiperate, swep, propachlor, metazachlor, alachlor, acetochlor, metolachlor, S-metolachlor, butachlor, pretilachlor, thenylchlor, aminocyclopyrachlor, aminocyclopyrachlor-methyl, aminocyclopyrachlor-potassium, trifluralin, pendimethalin, ethalfluralin, benfluralin, prodiamine, simazine, atrazine, propazine, cyanazine, ametryn, simetryn, dimethametryn, prometryn, indaziflam, triaziflam, metribuzin, hexazinone, isoxaben, diflufenican, diuron, linuron, fluometuron, difenoxuron, methyl-daimuron, isoproturon, isouron, tebuthiuron, benzthiazuron, methabenzthiazuron, propanil, mefenacet, clomeprop, naproanilide, bromobutide, daimuron, cumyluron, diflufenzopyr, etobenzanid, bentazon, tridiphane, indanofan, amitrole, fenchlorazole, clomazone, maleic hydrazide, pyridate, chloridazon, norflurazon, bromacil, terbacil, oxaziclomefone, cinmethylin, benfuresate, cafenstrole, pyrithiobac, pyrithiobac-sodium, pyriminobac, pyriminobac-methyl, bispyribac, bispyribac-sodium, pyribenzoxim, pyrimisulfan, pyriftalid, fentrazamide, dimethenamid, dimethenamid-P, ACN, bennzobicyclon, dithiopyr, triclopyr and a salt or ester thereof (butotyl ester, triethylammonium salt), fluroxypyr, fluroxypyr-meptyl, thiazopyr, aminopyralid and a salt thereof (potassium salt, triisopropanolammonium salt, choline salt), clopyralid and a salt thereof (olamine salt, potassium salt, triethylammonium salt, choline salt), picloram and a salt thereof (potassium salt, triisopropanolammonium salt, choline salt), dalapon, chlorthiamid, amidosulfuron, azimsulfuron, bensulfuron, bensulfuron-methyl, chlorimuron, chlorimuron-ethyl, cyclosulfamuron, ethoxysulfuron, flazasulfuron, flucetosulfuron, flupyrsulfuron, flupyrsulfuron-methyl-sodium, foramsulfuron, halosulfuron, halosulfuron-methyl, imazosulfuron, mesosulfuron, mesosulfuron-methyl, nicosulfuron, orthosulfamuron, oxasulfuron, primisulfuron, primisulfuron-methyl, propyrisulfuron, pyrazosulfuron, pyrazosulfuron-ethyl, rimsulfuron, sulfometuron, sulfometuron-methyl, sulfosulfuron, trifloxysulfuron-sodium, trifloxysulfuron, chlorsulfuron, cinosulfuron, ethametsulfuron, ethametsulfuron-methyl, iodosulfuron, iodosulfuron-methyl-sodium, metsulfuron, metsulfuron-methyl, prosulfuron, thifensulfuron, thifensulfuron-methyl, triasulfuron, tribenuron, tribenuron-methyl, triflusulfuron, triflusulfuron-methyl, tritosulfuron, picolinafen, beflubutamid, mesotrione, sulcotrione, tefuryltrione, tembotrione, isoxachlortole, isoxaflutole, benzofenap, pyrasulfotole, pyrazolynate, pyrazoxyfen, topramezone, flupoxam, amicarbazone, bencarbazone, flucarbazone, flucarbazone-sodium, ipfencarbazone, propoxycarbazone, propoxycarbazone-sodium, thiencarbazone, thiencarbazone-methyl, cloransulam, cloransulam-methyl, diclosulam, florasulam, flumetsulam, metosulam, penoxsulam, pyroxsulam, imazamethabenz, imazamethabenz-methyl, imazamox, imazamox-ammonium, imazapic, imazapic-ammonium, imazapyr, imazapyr-ammonium, imazaquin, imazaquin-ammonium, imazethapyr, imazethapyr-ammonium, clodinafop, clodinafop-propargyl, cyhalofop, cyhalofop-butyl, diclofop, diclofop-methyl, fenoxaprop, fenoxaprop-ethyl, fenoxaprop-P, fenoxaprop-P-ethyl, fluazifop, fluazifop-butyl, fluazifop-P, fluazifop-P-butyl, haloxyfop, haloxyfop-methyl, haloxyfop-P, haloxyfop-P-methyl, metamifop, propaquizafop, quizalofop, quizalofop-ethyl, quizalofop-P, quizalofop-P-ethyl, alloxydim, clethodim, sethoxydim, tepraloxydim, tralkoxydim, pinoxaden, pyroxasulfone, glufosinate, glufosinate-ammonium, glufosinate-P, glufosinate-P-sodium, bialafos, anilofos, bensulide, butamifos, paraquat, paraquat-dichloride, diquat and diquat-dibromide

Examples of the plant growth regulating agents include the following:

hymexazol, paclobutrazol, uniconazole, uniconazole-P, inabenfide, prohexadione-calcium, 1-methylcyclopropene, trinexapac and gibberellins.

Examples of the safeners include the following:

benoxacor, cloquintocet, cloquintocet-mexyl, cyometrinil, cyprosulfamide, dichlormid, dicyclonon, dietholate, fenchlorazole, fenchlorazole-ethyl, fenclorim, flurazole, fluxofenim, furilazole, isoxadifen, isoxadifen-ethyl, mefenpyr, mefenpyr-diethyl, mephenate, naphthalic anhydride and oxabetrinil.

The dosage of the composition of the present invention can vary depending on the mixing ratio of flumioxazin, saflufenacil, and glyphosate or a salt thereof, weather condition, formulation types, application time, application methods, application places, objective weeds and crops, and it is usually from about 1 to 30 g based on the total amount of the respective compounds per hectare. When the formulation is emulsifiable concentrate, wettable powder or suspension concentrate, the predetermined amount is usually diluted with about 100 to 2,000 liters of water per hectare and applied. Furthermore, when the composition of the invention is applied to weeds by a foliar treatment, an adjuvant is added to the dilution of the composition of the present invention so as to enhance the herbicidal activity against weeds.

In the method for controlling weeds of the present invention, a treatment with the composition of the present invention is applied to weeds or a place where emergence of weeds is predicted. The treatment to weeds includes a treatment to foliage of weeds and a treatment to soil after emergence of weeds. The treatment to a place where emergence of weeds is predicted includes, for example, a treatment to the soil surface before emergence of weeds. The method for controlling weeds of the present invention also includes that flumioxazin, saflufenacil, and glyphosate or a salt thereof are separately applied to weeds or a place where emergence of weeds is predicted.

The treating method of the composition of the present invention includes, for example, the following aspects: a method of spraying over the soil surface before sowing of crops and before emergence of weeds;
a method of spraying over the soil surface before sowing of crops and after emergence of weeds;
   a method of spraying over weeds before sowing of crops and after emergence of weeds;
   a method of spraying over the soil surface after sowing of crops and before germination of crops, and before emergence of weeds;
   a method of spraying over the soil surface after sowing of crops and before germination of crops, and after emergence of weeds;
   a method of spraying over weeds after sowing of crops and before germination of crops, and after emergence of weeds; a method of spraying over the soil surface in the presence of crops before germination of weeds;
   a method of spraying over the soil surface in the presence of crops after germination of weeds; and/or
   a method of spraying over weeds in the presence of crops after germination of weeds.

### EXAMPLES

The present invention will be described below by way of Examples, but the present invention is not limited to these Examples.

Formulation Examples are shown below.

### Formulation Example 1

(1) Gum arabic (20 g) is dissolved in 180 g of water to obtain an aqueous gum arabic. To the aqueous gum arabic, 37 g of flumioxazin and 37 g of saflufenacil are added, and then 300 g of glass beads each having a diameter of 1 mm are added, followed by stirring and further pulverization to obtain a pulverized slurry of flumioxazin and saflufenacil.
(2) To 119 g of the pulverized slurry in (1), 371 g of an aqueous 62% solution of a glyphosate-isopropylamine and 10 g of a silica/aluminum oxide mixture are added, followed by stirring to obtain an aqueous suspended pesticide composition.

### Formulation Example 2

(1) Gum arabic (20 g) is dissolved in 206 g of water to obtain an aqueous gum arabic. To the aqueous gum arabic, 37 g of flumioxazin and 11 g of saflufenacil are added, and then 300 g of glass beads each having a diameter of 1 mm are added, followed by stirring and further pulverization to obtain a pulverized slurry of flumioxazin and saflufenacil.
(2) To 119 g of the pulverized slurry in (1), 371 g of an aqueous 62% solution of a glyphosate-isopropylamine and 10 g of a silica/aluminum oxide mixture are added, followed by stirring to obtain an aqueous suspended pesticide composition.

### Formulation Example 3

(1) To 1,000 g of deionized water, 700 g of a polyoxyethylene tristyrylphenyl ether phosphoric acid ester potassium salt is added, followed by stirring until the potassium salt dissolves. To the solution, 14 g of a silicone emulsion, 70 g of a silica/aluminum oxide mixture, 300 g of flumioxazin and 300 g of saflufenacil are added, followed by stirring to obtain a slurry mixture containing flumioxazin and saflufenacil. The slurry mixture containing flumioxazin and saflufenacil is then subjected to wet pulverization to obtain a pulverized slurry.
(2) Deionized water (600 g) and 5 g of acid stable xanthan gum are added, followed by mixing with stirring to obtain an aqueous thickener solution.
(3) The pulverized slurry suspension (70 g) in (1) and 40 g of the aqueous thickener solution in (2) are added, followed by stirring to obtain a suspension containing flumioxazin and saflufenacil.
(4) A polyoxyethylene alkyl ether phosphoric acid ester ammonium salt (16 g) and 90 g of an aqueous 62% solution of a glyphosate-isopropylamine are added, followed by stirring to obtain an aqueous solution containing a glyphosate-isopropylamine.
(5) To the suspension containing flumioxazin and saflufenacil in (3), the aqueous solution containing a glyphosateisopropylamine in (4) is added, followed by stirring to obtain an aqueous suspended pesticide composition.

### [Herbicidal Activity and Phytotoxicity]

Herbicidal activity is evaluated by the following criteria and is divided into 0 to 100, where score of the case where the state of emergence or growth of test weeds upon examination is not completely or scarcely different from that in the case of no treatment is “0”, while score of the case where the test plant is completely dead, or emergence or growth is completely suppressed is “100”.

Phytotoxicity to crops is evaluated by the following criteria and is divided into 0 to 100, where score of the case where the state of emergence or growth of crops upon examination is not completely or scarcely different from that in the case of no treatment is “0”, while score of the case where the crops are completely dead is “100”. The “phytotoxicity” to be evaluated herein is symptom development which is judged to be caused by a treated compound, and is apparently distinguished from that caused by pests.

### Example 1

Plastic pots each having a diameter of 24 cm and a height of 21 cm were filled with the soil, and seeds of ivyleaf morningglory (Ipomoea hederacea) and barnyardgrass (Echinochloa crus-galli) were sown. Cultivation was carried out in a greenhouse until seedlings of ivyleaf morningglory reach the third-leaf stage and seedlings of barnyardgrass reach the stage between fourth- and fifth-leaf. A water dilution of a flumioxazin water dispersible granule (water dispersible granule containing 51% of flumioxazin, manufactured by Valent USA Corporation under the trade name of Valor SX), a water dilution of saflufenacil and a water dilution of a glyphosate potassium salt (liquid formulation containing 48% of a glyphosate potassium salt, manufactured by Nissan Chemical Industries, Ltd. under the trade name of Roundup Maxload) were mixed, and the obtained composition was uniformly sprayed over the pots using a sprayer in an amount of 500 L/ha. The water dilution of saflufenacil was prepared by dissolving a predetermined amount of saflufenacil in acetone containing 2% (w/v) of Tween 20 (surfactant, manufactured by Tokyo Chemical Industry Co., Ltd.) and diluting the solution with water so that the acetone concentration will be 10 volume %.

After a chemical treatment, the pots were placed in a greenhouse, and then seedlings of ivyleaf morningglory and barnyardgrass were cultivated. Fourteen days after the chemical treatment, seeds of corn (cultivars: Pioneer 31P41) and soybean (cultivars: Williams 82) were sown in the above pots.

Seedlings of plants were further cultivated in a greenhouse and, 20 days after the chemical treatment, herbicidal activity was evaluated, while 38 days after the chemical treatment (24 days after sowing of crop), phytotoxicity to crops was evaluated. The results are shown in Table 1 and Table 2.

TABLE 1

| | Amount of | Herbicidal activity | |
|---|---|---|---|
| | ingredient | Ivyleaf | |
| Test compounds | (g/ha) | morningglory | Barnyardgrass |
| Flumioxazin | 70 | 100 | 100 |
| + Saflufenacil | + 20 | | |
| + Glyphosate potassium salt | + 1,000 | | |

TABLE 2

| | Amount of | | |
|---|---|---|---|
| | ingredient | Phytotoxicity to crops | |
| Test compounds | (g/ha) | Corn | Soybean |
| Flumioxazin | 70 | 0 | 0 |
| + Saflufenacil | + 20 | | |
| + Glyphosate potassium salt | + 1,000 | | |

### Example 2

Plastic pots each having a diameter of 24 cm and a height of 21 cm were filled with the soil. A water dilution of a flumioxazin water dispersible granule (water dispersible granule containing 51% of flumioxazin, manufactured by Valent USA Corporation under the trade name of Valor SX), a water dilution of saflufenacil and a water dilution of a glyphosate potassium salt (liquid formulation containing 48% of a glyphosate potassium salt, manufactured by Nissan Chemical Industries, Ltd. under the trade name of Roundup Maxload) were mixed, and the obtained composition was uniformly sprayed over the pots using a sprayer in an amount of 500 L/ha. The water dilution of saflufenacil was prepared by dissolving a predetermined amount of saflufenacil in acetone containing 2% (w/v) of Tween 20 (surfactant, manufactured by Tokyo Chemical Industry Co., Ltd.) and diluting the solution with water so that the acetone concentration will be 10 volume %.

After a chemical treatment, seeds of redroot pigweed (Amaranthus retroflexus) and southern crabgrass (Digitaria ciliaris) were sown in the above pots. The pots were put in greenhouse and then seedlings of redroot pigweed and southern crabgrass were cultivated.

Twenty days after the chemical treatment (20 days after sowing), herbicidal activity was evaluated. The results are shown in Table 3.

TABLE 3

| | Amount of | Herbicidal activity | |
|---|---|---|---|
| | ingredient | Redroot | Southern |
| Test compounds | (g/ha) | pigweed | crabgrass |
| Flumioxazin | 70 | 100 | 100 |
| + Saflufenacil | + 20 | | |
| + Glyphosate potassium salt | + 1,000 | | |

### Example 3

Plastic pots each having a diameter of 24 cm and a height of 21 cm were filled with the soil. A water dilution of saflufenacil was prepared. A mixed solution of a water dilution of a flumioxazin water dispersible granule (water dispersible granule containing 51% of flumioxazin, manufactured by Valent USA Corporation under the trade name of Valor SX) and a water dilution of a glyphosate potassium salt (liquid formulation containing 48% of a glyphosate potassium salt, manufactured by Nissan Chemical Industries, Ltd. under the trade name of Roundup Maxload) was prepared. A mixed solution of a water dilution of saflufenacil, a water dilution of a flumioxazin water dispersible granule and a water dilution of a glyphosate potassium salt was prepared. Each of the solutions thus prepared above was uniformly sprayed over the pots using a sprayer in an amount of 500 L/ha. The water dilution of saflufenacil was prepared by dissolving a predetermined amount of saflufenacil in acetone containing 2% (w/v) of Tween 20 (surfactant, manufactured by Tokyo Chemical Industry Co., Ltd.) and diluting the solution with water so that the acetone concentration will be 10 volume %.

After a chemical treatment, the pots were put in a greenhouse.

Twenty-one days after the chemical treatment, seeds of ivyleaf morningglory (Ipomoea hederacea) were sown in the above pots.

Seedling of the plant were cultivated in the greenhouse and, 45 days after the chemical treatment (24 days after sowing), herbicidal activity was evaluated. The results are shown in Table 4.

TABLE 4

| | Amount of | |
|---|---|---|
| | ingredient | Herbicidal activity |
| Test compounds | (g/ha) | Ivyleaf morningglory |
| Saflufenacil | 20 | 45 |
| Flumioxazin | 70 | 35 |
| + Glyphosate potassium salt | + 1,000 | |
| Flumioxazin | 70 | 100 |
| + Saflufenacil | + 20 | |
| + Glyphosate potassium salt | + 1,000 | |

### Example 4

Plastic pots each having a diameter of 24 cm and a height of 21 cm were filled with the soil. A water dilution of a glyphosate potassium salt (liquid formulation containing 48% of a glyphosate potassium salt, manufactured by Nissan Chemical Industries, Ltd. under the trade name of Roundup Maxload) was prepared. A mixed solution of a water dilution of a flumioxazin water dispersible granule (water dispersible granule containing 51% of flumioxazin, manufactured by Valent USA Corporation under the trade name of Valor SX) and a water dilution of a saflufenacil was prepared. A mixed solution of a water dilution of a glyphosate potassium salt, a water dilution of a flumioxazin water dispersible granule and a water dilution of Saflufenacil was prepared. Each of the solutions thus prepared above was uniformly sprayed over the pots using a sprayer in an amount of 500 L/ha. The water dilution of saflufenacil was prepared by dissolving a predetermined amount of saflufenacil in acetone containing 2% (w/v) of Tween 20 (surfactant, manufactured by Tokyo Chemical Industry Co., Ltd.) and diluting the solution with water so that the acetone concentration will be 10 volume %.

After a chemical treatment, the pots were put in a greenhouse.

Nine days after the chemical treatment, seeds of barnyardgrass (Echinochloa crus-galli) were sown.

Seedlings of the plant were cultivated in the greenhouse and, 29 days after the chemical treatment (20 days after sowing), herbicidal activity was evaluated. The results are shown in Table 5.

TABLE 5

| | Amount of | Herbicidal |
|---|---|---|
| | ingredient | activity |
| Test compounds | (g/ha) | Barnyardgrass |
| Glyphosate potassium salt | 1,000 | 0 |
| Flumioxazin | 70 | 55 |
| + Saflufenacil | + 20 | |
| Flumioxazin | 70 | 75 |
| + Saflufenacil | + 20 | |
| + Glyphosate potassium salt | + 1,000 | |

### Example 5

Plastic pots each having a diameter of 21 cm and a height of 17 cm in height were filled with the soil, and seeds of ivyleaf morningglory (Ipomoea hederacea) and barnyardgrass (Echinochloa crus-galli) were sown. Cultivation was carried out in a greenhouse until seedlings of ivyleaf morningglory reach the second-leaf stage and seedlings of barnyardgrass reach the stage between second- and third-leaf. A water dilution of a flumioxazin water dispersible granule (water dispersible granule containing 51% of flumioxazin, manufactured by Valent USA Corporation under the trade name of Valor SX), a water dilution of saflufenacil and a water dilution of a glyphosate potassium salt (liquid formulation containing 48% of a glyphosate potassium salt, manufactured by Nissan Chemical Industries, Ltd. under the trade name of Roundup Maxload) were mixed, and the obtained composition was uniformly sprayed over the pots using a sprayer in an amount of 500 L/ha. The water dilution of saflufenacil was prepared by dissolving a predetermined amount of saflufenacil in acetone containing 2% (w/v) of Tween 20 (surfactant, manufactured by Tokyo Chemical Industry Co., Ltd.) and diluting the solution with water so that the acetone concentration will be 10 volume %.

After a chemical treatment, the pots were placed in a greenhouse, and then seedlings of ivyleaf morningglory and barnyardgrass were cultivated. Twenty-eight days after the chemical treatment, herbicidal activity was evaluated, and then seeds of soybean (cultivars: Williams 82) were sown in the above pots. Seedling of the plants were further cultivated in the greenhouse and, 51 days after the chemical treatment (23 days after sowing), phytotoxicity to crops was evaluated. The results are shown in Table 6 and Table 7.

TABLE 6

| | Amount of | Herbicidal activity | |
|---|---|---|---|
| | ingredient | Ivyleaf | |
| Test compounds | (g/ha) | morningglory | Barnyardgrass |
| Flumioxazin | 20 | 100 | 100 |
| + Saflufenacil | + 200 | | |
| + Glyphosate potassium salt | + 1,000 | | |
| | 70 | 100 | 100 |
| | + 70 | | |
| | + 1,000 | | |
| | 200 | 100 | 100 |
| | + 20 | | |
| | + 1,000 | | |

TABLE 7

| | Amount of | Phytotoxicity to |
|---|---|---|
| | ingredient | crops |
| Test compounds | (g/ha) | Soybean |
| Flumioxazin | 20 | 0 |
| + Saflufenacil | + 200 | |
| + Glyphosate potassium salt | + 1,000 | |
| | 70 | 0 |
| | + 70 | |
| | + 1,000 | |
| | 200 | 0 |
| | + 20 | |
| | + 1,000 | |

### Example 6

A mixed solution of flumioxazin, saflufenacil and a glyphosate isopropylamine salt is uniformly sprayed over the soil surface of pots in which seedlings of grape, Satsuma orange, peach and almond are cultivated.

Seedlings of the plant are cultivated outdoors and, 21 days after the chemical treatment, herbicidal activity against naturally occurring weeds is evaluated. As a result, it is possible to obtain a high control activity against weeds without causing significant phytotoxicity to crops.

According to the present invention, it becomes possible to control a wide variety of weeds in a farm crop field, a vegetable field, a tree land or a non-cultivated land without causing significant phytotoxicity to crops.

1. A herbicidal composition comprising flumioxazin, saflufenacil, and glyphosate or a salt thereof.

2. The herbicidal composition according to claim 1, wherein the weight ratio of flumioxazin to saflufenacil is from 1:0.02 to 1:30.

3. The herbicidal composition according to claim 1, wherein the weight ratio of flumioxazin to glyphosate or a salt thereof is from 1:0.2 to 1:200 in terms of the weight of glyphosate.

4. The herbicidal composition according to any one of claims 1 to 3, wherein the salt of glyphosate is a potassium salt, a sodium salt, an isopropylamine salt, a trimesium salt, an ammonium salt, a diammonium salt or a guanidine derivative salt.

5. The herbicidal composition according to any one of claims 1 to 3, wherein the salt of glyphosate is a potassium salt.

6. A method for controlling weeds, which comprises applying an effective amount of flumioxazin, saflufenacil, and glyphosate or a salt thereof to soil or weeds in a place where the weeds grow or will grow.

7. The method according to claim 6, wherein the weight ratio of flumioxazin to saflufenacil is from 1:0.02 to 1:30.

8. The method according to claim 6, wherein the weight ratio of flumioxazin to glyphosate or a salt thereof is within a range from 1:0.2 to 1:200 in terms of the weight of glyphosate.

9. The method according to any one of claims 6 to 8, wherein the salt of glyphosate is a potassium salt, a sodium salt, an isopropylamine salt, a trimesium salt, an ammonium salt, a diammonium salt or a guanidine derivative salt.

10. The method according to any one of claims 6 to 8, wherein the salt of glyphosate is a potassium salt.

11. The method according to claim 6, which is a method for controlling weeds in a soybean field and a corn field.

12. The method according to claim 6, which is a method for controlling weeds in a tree land.
